(19) United States
(12) Patent Application Publication
(10) Pub. No.: US 2014/0149131 A1
(43) Pub. Date: May 29, 2014

(54) METHODS AND SYSTEMS FOR DRUG DIVERSION TRACKING

(71) Applicant: Covectra, Inc., (US)

(72) Inventors: David Bear, Weston, MA (US); Stephen M. Wood, Waterford, CT (US); Terrence P. O'Neill, Plymouth, MA (US); George Kechter, Peoria, IL (US); Richard Smith, Pottstown, PA (US)

(73) Assignee: COVECTRA, INC., Westborough, MA (US)

(21) Appl. No.: 13/782,244

(22) Filed: Mar. 1, 2013

Related U.S. Application Data
(60) Provisional application No. 61/730,122, filed on Nov. 27, 2012.

(51) Int. Cl. G06F 19/00

(52) U.S. Cl. CPC G06F 19/3431
USPC 705/2

(57) ABSTRACT

Methods and systems of patient compliance monitoring. Patient compliance monitoring includes receiving, from a user, a specification of a patient and retrieving prescription data associated with the specification. Compliance monitoring further includes receiving one or more codes associated with a dispensed prescription and determining whether the patient is compliant with the prescription data as a function of the prescription data and the one or more codes. Compliance monitoring also includes communicating an indication of whether the patient is compliant to the user.

### CROSS REFERENCE TO RELATED APPLICATIONS

This application claims priority to and the benefit of U.S. Provisional Application No. 61/730,122, filed Nov. 27, 2012, entitled, “Methods and Systems for Drug Diversion Tracking,” the disclosure of which is hereby incorporated by reference in its entirety.

### BACKGROUND

Embodiments described herein relate generally to methods and systems for identifying, tracking and authenticating a good based on a unique signature associated with the good, and particularly to systems and methods for tracking compliance with usage and possession of restricted-distribution goods, such as prescription drugs.

It can be necessary to track usage and/or movement of the goods even after the goods have left the supply chain, such as some prescription drugs that are subject to restricted and/or controlled distribution. For example, drugs used to treat opiate addiction are usually opioids as well, and require strict monitoring for abuse after being dispensed since the patients are typically former opioid addicts with a history of substance abuse and/or drug trafficking Tracking usage of a dispensed drug not only ensures that the patient is in possession of the drug, but provides the added benefit of monitoring patient compliance with a prescribed dosing regimen. Tracking movement of a dispensed drug also allows law enforcement to ascertain whether a person in possession of a controlled drug is legally entitled to do so, where the person in illegal possession might have sourced the dispensed drug from, and so on. However, traditional supply chain tracking approaches are insufficient for tracking goods outside the supply chain, such as dispensed drugs.

What is needed is a system for tracking restricted-distribution goods that deters diversion by providing for tracking of goods after dispensing to a consumer.

### SUMMARY

Methods and systems of patient compliance monitoring are described herein. In some embodiments, patient compliance monitoring includes receiving, from a user, a specification of a patient and retrieving prescription data associated with the specification. Compliance monitoring further includes receiving one or more dosage codes associated with a dispensed prescription and determining whether the patient is compliant with the prescription data as a function of the prescription data and the one or more dosage codes. Compliance monitoring also includes communicating an indication of whether the patient is compliant to the prescriber.

In some embodiments, systems and methods of the invention are operable for prescription drug tracking as described herein. Drug tracking includes receiving one or more dosage codes associated with a dispensed prescription and retrieving prescription data associated with at least one dosage code from the one or more dosage codes. Drug tracking also includes retrieving a specification of a patient associated with the prescription data and determining whether the dispensed prescription was diverted as a function of the specification of the patient. An indication of whether the dispensed prescription was diverted is communicated to a user.

### BRIEF DESCRIPTION OF THE DRAWINGS

FIG. 1 is a schematic illustration of a system according to an embodiment.

FIGS. 2A-2B are exemplary illustrations of box codes and dosage codes of box and pill packets, respectively, of a controlled drug to be dispensed, according to embodiments.

FIGS. 3A-3B are images of a pharmaceutical pill having unique features that can be included in a unique signature of a dosage code for each pill, according to an embodiment.

FIGS. 4A-4E are exemplary screen shots provided by the monitor interface of FIG. 1, according to embodiments.

FIG. 5 is a schematic illustration of the compliance monitor of FIG. 1, according to an embodiment.

FIG. 6 is a flowchart of a method of determining compliance, according to an embodiment.

FIG. 7 is a flowchart of a method of determining diversion, according to an embodiment.

### DETAILED DESCRIPTION

Systems and methods for drug tracking and/or patient compliance monitoring are described herein. Controlled substances or drugs are a necessary evil for society: while deemed as habit-forming and candidates for abuse by consumers, they provide accepted therapeutic benefits when administered judiciously. As such, regulating controlled drugs is a substantial component of federal US drug policy, and encompasses regulation of manufacture, importation, possession, use and distribution of these drugs. While some controlled drugs may never be administered (e.g. when no known medical use of the drug exists), a large number of controlled drugs are made available for dispensing via prescriptions. These generally include some opioids such as codeine, hydrocodone, oxycodone or psychostimulants such as methylphenidate and amphetamine, opioid intermediates, depressants such as some barbiturates, benzodiazepines, narcotics, steroids such as anabolic steroids, and/or the like.

Like most prescription drugs, the movement of controlled drugs is from the drug manufacturers to distributors (including dispensing pharmacies, collectively considered the supply chain) and ultimately to individual consumers. Supply chains are tightly regulated to address the challenge of counterfeit, adulterated, and diverted drugs that replace the controlled drugs, and the US Food and Drug Administration (FDA) is working to develop standards and identify technologies that will secure pharmaceutical supply chains. However, a myriad of serialization technologies are already employed by pharmaceutical companies and other supply chain participants, ranging from on-dosage technology to secure shipping containers to on-package technology. In some approaches, the application of security features to individual dosages is employed. Some of these security features are more evident to the naked eye (e.g. holograms), while others are more covert (e.g. invisible inks), and yet others are intrinsic to the dosage form itself. For example, a random pattern unique to the individual dosage (which can be a capsule, tablet, pill, etc.) can be captured during manufacture and used for subsequent identification, tracking, tracing, and/or authentication activities, as described in more detail in U.S. patent application Ser. No. 13/507,320 filed on Jun. 21, 2012 and entitled “SYSTEM AND METHODS FOR TRACKING AND AUTHENTICATING GOODS,” the entire disclosure of which is incorporated herein by reference. As also disclosed by the '320 application, a database can be configured to store information relating to the good and its corresponding unique signature, and can be referenced for each of the activities listed above.

While enforcement and tracking at the supply chain level is hence elaborate, tracking the activity of the individual consumer who receives the controlled drug upon prescription still provides a challenge. Such tracking is important for legal as well as patient compliance reasons. From a law enforcement perspective, it is important to ensure that the patient does not sell or otherwise illegally distribute the controlled drug to others. From a patient health perspective, some medical conditions treated by the controlled drugs require the patient to consume the drug per the prescribed quantity and schedule. In other words, patient adherence and/or compliance to the treatment is critical, and a lack thereof can result in increased rates of morbidity, healthcare expenditure to the patient and/or society, escalation of therapy, and even mortality.

Accordingly, embodiments described herein extend available serialization techniques and databases to link, at the time of drug dispensing (i.e., when the drug leaves the supply chain and is given to the prescribed patient), prescription information and patient information to dispensed prescription drugs at the single dosage level. From a law enforcement perspective, this approach cures the deficiencies of the prior art by permitting prescription and/or patient information lookup based on the unique identifier(s) of the single dosages alone. For example, controlled drugs found on an individual can be verified if they indeed were prescribed to that individual, or to someone else.

From a patient compliance perspective, this approach cures the deficiencies of the prior art by determining if the patient is consuming the controlled drug as prescribed by comparing prescription and/or patient information with the single dosages consumed and/or not consumed by the patient. For example, suppose a patient is prescribed twelve tablets to be taken once daily per the prescription and/or patient information, and is required to scan or otherwise identify to a system of the invention all remaining tablets every four days. The patient will be deemed compliant if he scans eight unopened dosage packets after four days, and four unopened dosage packets after eight days. In addition or alternatively, the patient will be deemed compliant if he scans four opened dosage packets after four days, eight opened dosage packets after eight days, and twelve opened dosage packets after twelve days. Of course, with little additional effort, the patient may be asked to present both opened and unopened packets for prescriber review.

In some embodiments, the disclosed systems and methods prevent drug diversion and improve patient compliance, since patients are more likely to adhere to the prescribed treatment when they anticipate serious legal and health consequences related to non-compliance.

In some embodiments, the disclosed systems and methods may be implemented in addition to or within established regulatory practices. For example, existing channels of prescription reporting by dispensing entities to state and other prescription drug monitoring programs (PDMPs) can be enhanced to include patient compliance determined by the invention. Similarly, existing channels between enforcement agencies (e.g. the Office of Diversion Control of Drug Enforcement Administration at the US Department of Justice) and pharmaceutical supply chain participants can be enhanced to include the reporting of any diversion determined by the invention.

In some embodiments, the disclosed systems and methods are useful for monitoring continued possession and/or prescribed use of a controlled drug by a patient. Such systems can be used by physicians, pharmacists, law enforcement authorities, and others that form the last step in a supply chain, before the consumer (e.g. a patient). In some scenarios, a physician can prescribe, via a prescription, the controlled substance or drug to a patient. The controlled drug being dispensed can have one or more unique identifiers or codes associated with each level of packaging of the controlled drug. In other words, at least one unique code can be associated with each individual dosage such as a single pill packet, with each box containing one or more individual dosages, with each carton containing one or more boxes, and so on. In some embodiments, the unique codes are serialization codes such as quick response (QR) bar codes, universal product codes (UPC), three dimensional (3D) structures, an alphanumeric string such as a serialization number, and/or the like. In some embodiments, the unique codes are radio-frequency identification (RFID) codes. Examples of other unique codes are described in U.S. patent application Ser. No. 13,507,320 entitled “Systems and Methods for Tracking and Authenticating Goods”, filed Jun. 21, 2012, the entire disclosure of which is incorporated herein in its entirety.

Typically, after receiving a prescription from his physician, a patient has his prescription filled at a pharmacy, at the physician's office, or any suitable dispensing entity. Aspects of the system permit the pharmacy, while dispensing the prescribed quantity of the controlled drug (e.g. a box containing multiple, individual dosages or pill packets), to combine, link, interlink, or otherwise associate the patient information with prescription data. In some embodiments, the nature of the association between the patient information and the prescription data is a function of a prevailing regulatory standard such as, for example, the Health Insurance Portability and Accountability Act (HIPAA).

In some embodiments, the patient information can include, but is not limited to, one or more of a patient identifier of the patient, a name of the patient, an age of the patient, a gender of the patient, a daily dosage of the controlled drug for the patient, a social security number of the patient, a driver license number of the patient, or a prescription drug coverage provider of the patient. The patient information can be provided by the physician, entered by the pharmacy during dispensing, based on previously stored patient information in the database, and/or the like.

In some embodiments, the prescription data can include, but is not limited to, one or more of a prescription number, a prescription date, an identifier of a dispensed prescription drug, a dispense date, a box code associated with the dispensed prescription, one or more dosage codes associated with the box code, a prescribed or dosing schedule of the prescription drug, or one or more identifiers associated with each dosage code. In some embodiments, the dosing schedule is gleaned from the daily dosage specification of the patient information that is associated with the prescription data.

In some embodiments, a direct and rapid method to engage trackability for deterrence of illicit diversion is to associate, at the dispensing site, patient identification, the site of dispensing as a number, the prescription number, and a unique identifier on the unit of sale (e.g., a barcode uniquely identifying a carton containing uniquely identifiable unit doses of medication (units of use).

The box code and/or the individual dosage codes can be entered into the system by any suitable means (e.g. via an optical scanner, a RFID scanner, a camera, by manual entry, and so on) to be included in the prescription data. The patient information and the prescription (which specifies the dosing regimen chosen by the prescriber) is stored as associated in a database or any other suitable memory, and the box and/or unit of sale is then provided to the patient. In some embodiments, the box code and the dosage codes are RFID codes, and a RFID scanner of the system can simultaneously detect both during scanning the box. In some embodiments, a 2D barcode on the unit of sale is operable to open a table containing 2D bar codes of the contained individual units of use.

After dispensing, aspects of the drug tracking system permit the patient or any other user to scan the box code and/or the dosage codes at any suitable location (e.g. by returning to the pharmacy or the physician's office, at another location, at a personal scanning device, and/or the like). In some embodiments, a scanner or a camera on a stand-alone kiosk that is accessible to the patient can be employed for scanning the various codes. In some embodiments, a cloud-based application running on a Smartphone of patient can be used to capture optical images of the box code and/or dosage codes via a camera of the Smartphone. The patient can then upload the images via a mobile communication network, by connecting his Smartphone to a networked computing device, and/or the like. In some embodiments, the patient can be legally required to return to the dispensing pharmacy periodically. A user, such as a pharmacy employee, can enter a specification of the patient into the system, which can be any aspect of the patient information. The patient specification is used to retrieve the prescription data associated therewith, which includes one or more dosage codes, as described earlier. The user then scans the individual units of use to verify usage in accordance with the prescribed regimen.

The retrieved dosage codes of the pill packets are compared with the retrieved code within the dispensed unit of sale. In some embodiments, the patient is deemed to be compliant and/or have maintained possession of the controlled drug if the scanned dosage units match the dosage of the prescription. In other words, the patient is in legal possession of all the scanned pill packets. In some embodiments, the patient is deemed to be noncompliant and/or in improper possession of the controlled drug when at least one of the scanned codes on the units of use does not match the codes specified by the unit of sale table. In other words, the patient is in illegal possession of at least one of the scanned pill packets. In some embodiments, the patient is deemed to be noncompliant and/or having improperly diverted the controlled drug when the number of scanned dosages does not match the number of dosage codes of the prescription data: in other words, the patient has scanned fewer or more pill packets than the dispensed quantity at a given date.

In some embodiments, each code of a unit dose (e.g. a single pill packet) can be indicative of whether the unit dosage has been consumed by the patient. For example, each dosage code can include a first indicator that is printed across a seal of the pill packet and is destroyed when the seal is necessarily broken to retrieve the pill, and a second indicator that is printed on another portion of the pill packet, or otherwise provided such that remains substantially intact even after the pill packet is torn open. The patient can be deemed compliant and/or having adhered to the dosing schedule when the number of valid first indicators of the scanned dosage codes corresponds to a remaining duration of the dosing schedule, as determined from the prescription data. In other words, the patient is deemed to have the correct number of unopened pill packets left. The patient can additionally and/or alternatively be deemed to be in possession of all the dispensed medication when the number of valid second indicators of the scanned dosage codes corresponds to the entirety of the dosing schedule. In other words, the patient is deemed to have the correct number and unit of sale specified codes on pill packets, whether opened or unopened.

For example, suppose the prescription requires the patient to take a pill everyday for 12 days, and the patient is accordingly provided 12 pill packets with codes, each with a first and a second indicator as described above. The codes, including the first and second indicators, are stored in a database as part of the prescription data (unit of sale #, Rx#, pharmacy locator code associated with the patient. If all the pill packets are scanned on day 7, the system can deem the patient compliant with the dosing schedule if one or more of the following are satisfied: a) all 12 second indicators are valid, indicating that the patient is legal possession of all 12 dispensed and subsequently scanned pill packets, and b) 5 or 6 valid first indicators are detected (depending on whether the patient has consumed his medication of day 7), indicating that the patient has the correct number of unopened pill packets left.

Aspects of the invention also provide systems and methods for determining whether a prescription/controlled drug has been diverted by the patient associated with the prescription. For example, law enforcement can utilize the system for determining a patient and/or pharmacy associated with unclaimed controlled drugs of unknown origin, associated with controlled drugs found on a suspect claiming to be the lawful recipient of the drugs, and/or associated with controlled drugs found on an illicit drug dealer. A user of such a drug diversion tracking system can scan the individual pill packets of the unclaimed drug and/or otherwise enter the dosage codes associated with the unclaimed drug, via an optical scanner for example. Prescription data that includes or is otherwise associated with the codes is retrieved from the database that stores the prescription data. In this manner, a user such as a law enforcement official can obtain prescription information associated with the codes, such as the dispensing pharmacy and/or a prescribing physician. Law enforcement can contact the dispensing pharmacy and/or the prescribing physician to obtain additional information.

In some embodiments, patient information associated with the prescription data can be retrieved from the database. In some embodiments, how patient information is stored and can be retrieved is a function of a regulatory standard such as HIPAA and state regulations. In this manner, law enforcement can determine the owner of the drugs without contacting the dispensing pharmacy and/or the prescribing physician.

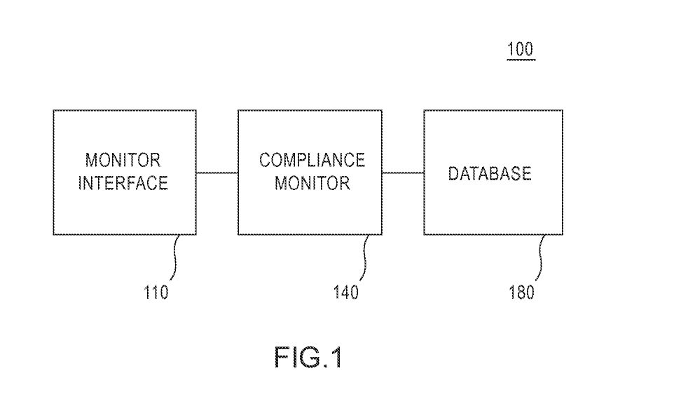

FIG. 1 is a schematic illustration of an environment or system 100 within which aspects of the invention may be implemented. The system 100 is operable for use, via a monitor interface 110, for drug tracking and compliance monitoring. The system 100 includes also includes a compliance monitor 140 usable via the monitor interface 110, and a database 180. The various components of the system 100 may be in communication as indicated by lines in FIG. 1 via a network, which may be any type of network (e.g., a local area network or LAN, a wide area network or WAN, a virtual network, a telecommunications network, and/or the internet) implemented as a wired network and/or a wireless network. Any or all communications may be secured (e.g., encrypted) or unsecured, as is known in the art. Each of the monitor interface 110, the compliance monitor 140, and the database 180 can include a personal computer, a server, a work station, a tablet, a mobile device, a cloud computing environment, an application or a module running on any of these platforms, and/or the like.

In some embodiments, at least some aspects of the monitor interface 110 and the compliance monitor 140 are commonly owned. In some embodiments, the monitor interface 110 is a third party device having software and/or hardware components in common ownership with the compliance monitor 140. For example, the monitor interface 110 can be a third-party laptop or tablet personal computing (PC) device that has a scanner and/or scanner software in common ownership with the compliance monitor 140. In some embodiments, the monitor interface 110 can include a stand-alone kiosk, booth or terminal with network connectivity to the compliance monitor 140.

In some embodiments, the system 100 is configurable for customized use with a single prescription drug being dispensed. Said another way, the system 100 does not require a specification of the drug being dispensed to be part of the patient and/or prescription information.

The monitor interface 110 is configurable to receive the patient information, and/or the prescription data via one or more input devices, in any suitable manner. The input device(s) can include, but are not limited to, a keyboard, a mouse, a touchscreen, a microphone, a camera, a scanner, and/or the like. In some embodiments, the monitor interface 110 includes an optical scanner for scanning box codes and/or dosage codes associated with a controlled drug to be dispensed. In some embodiments the box and dosage codes include RFID codes, and the monitor interface 110 includes an RFID scanner and/or detector.

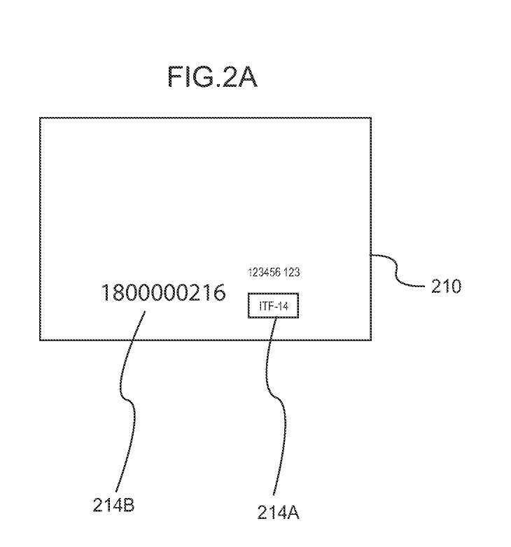

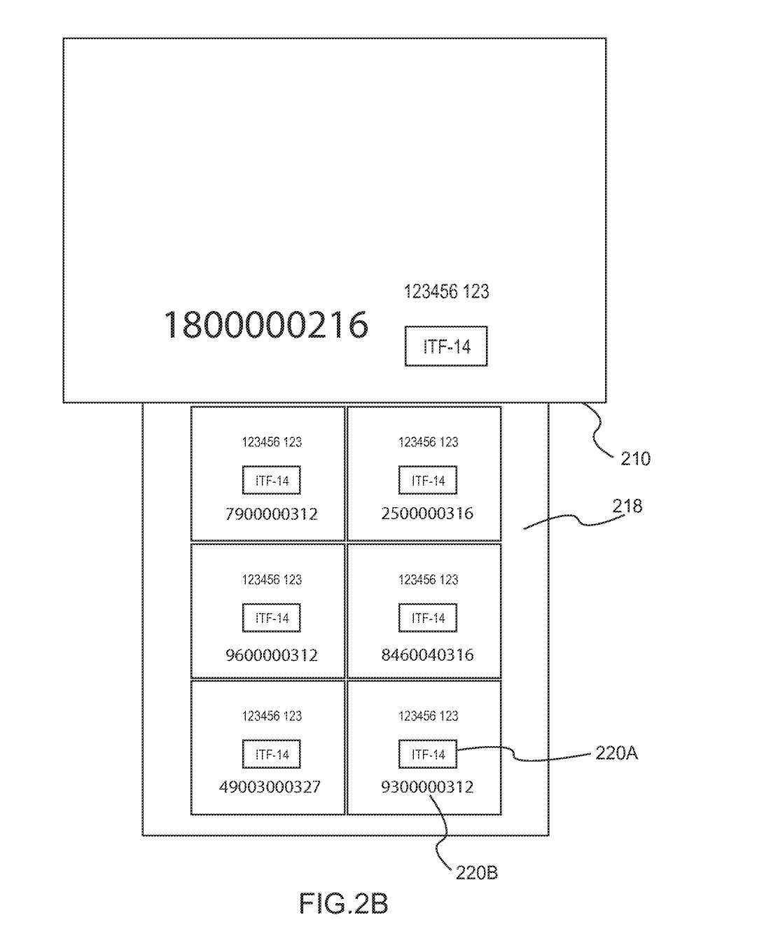

FIG. 2A illustrates an exemplary embodiment of a box 210 having a box code 214A that is a QR bar code, and a box code 214B that is a serialization number. As best illustrated in FIG. 2B, the box 210 can hold multiple pill packets 218, each with its own unique codes. The pill packets 218 can be, for example, blister packs having one or more unit doses per pack. As shown in FIG. 2B, the pill packet 218 is a multiple unit dose blister pack with perforations to allow the user to easily separate individual dosages from the pill packet 218. Similar to the box 210, the individual unit doses (e.g., bottom left portion of the blister pack) have a dosage code 220A that is a QR bar code, and another dosage code 220B that is a serialization number.

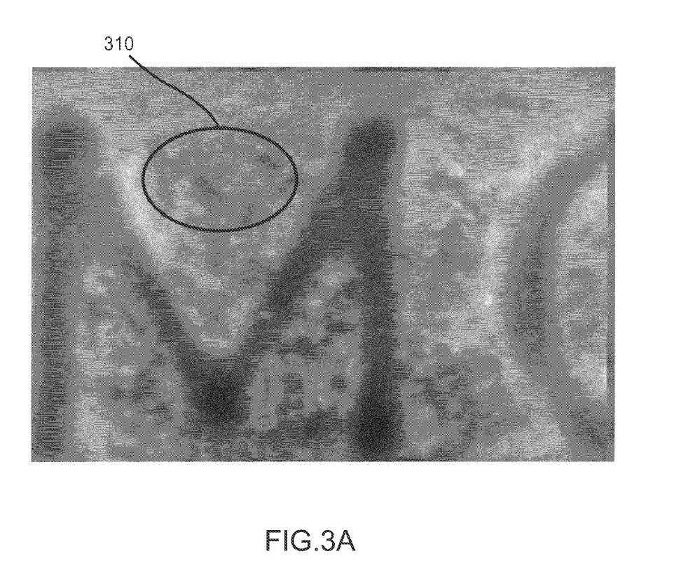

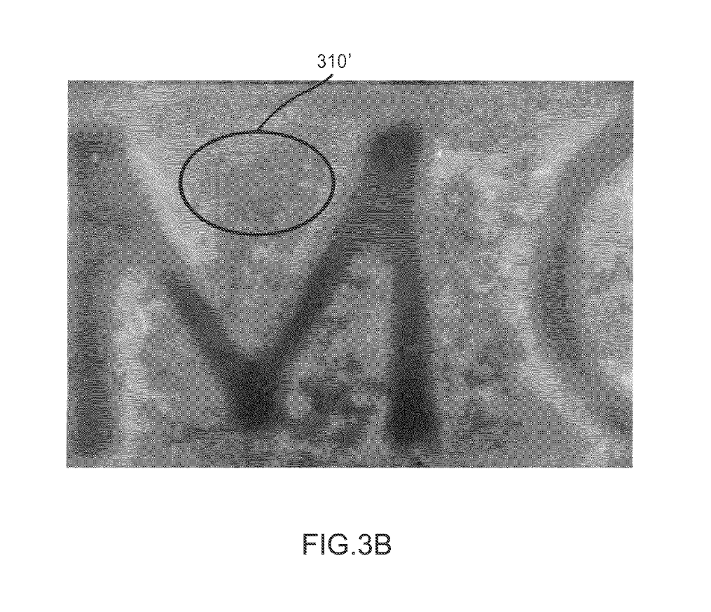

FIGS. 3A-3B are magnified images of a portion of a surface of a first pill and corresponding portion of a surface of a second pill, respectively. The first and second pills are each produced using the same or similar compositions. Intrinsic variations in the surface of the first pill from the second pill are observable (and have been identified, as an example, by the reference numbers 310 and 310′, respectively). Corresponding portions 310, 310′ of the first and second pill have varied patterns of lightness and darkness on their respective portions, which may be used as the unique signatures of the respective pills, and as part of the dosage code associated with each pill.

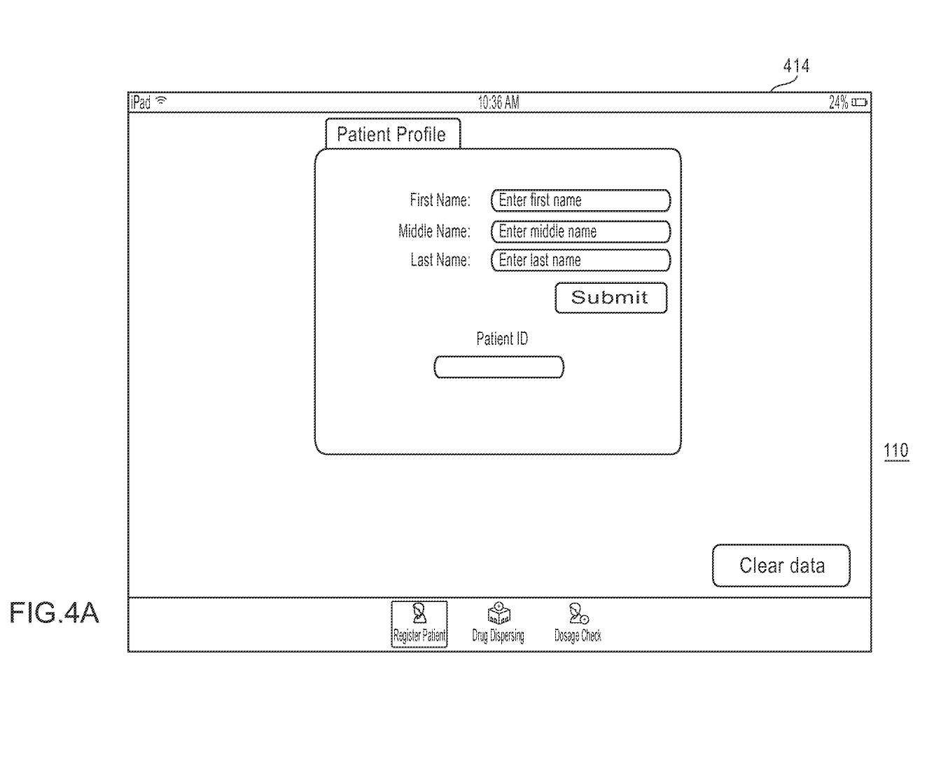

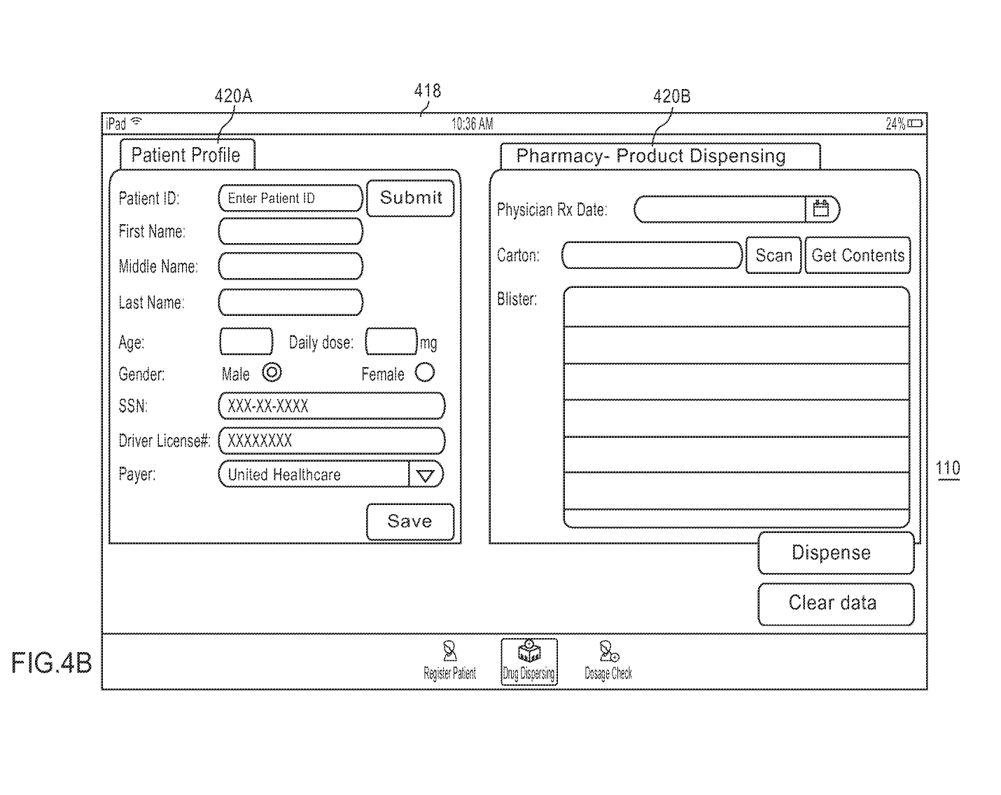

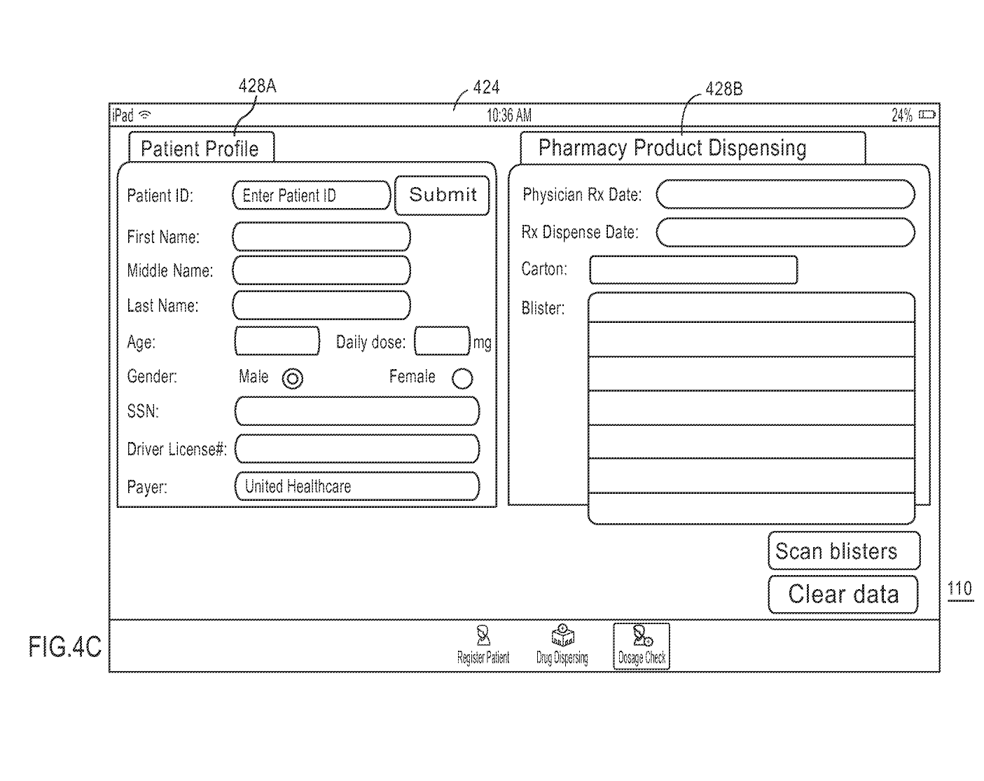

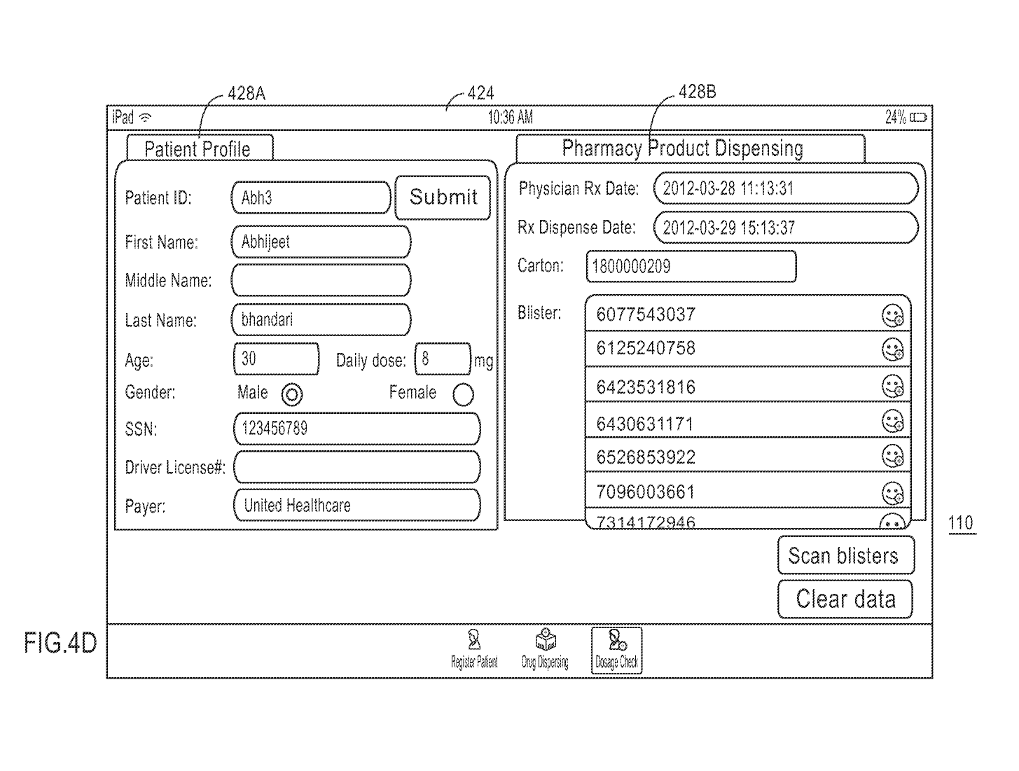

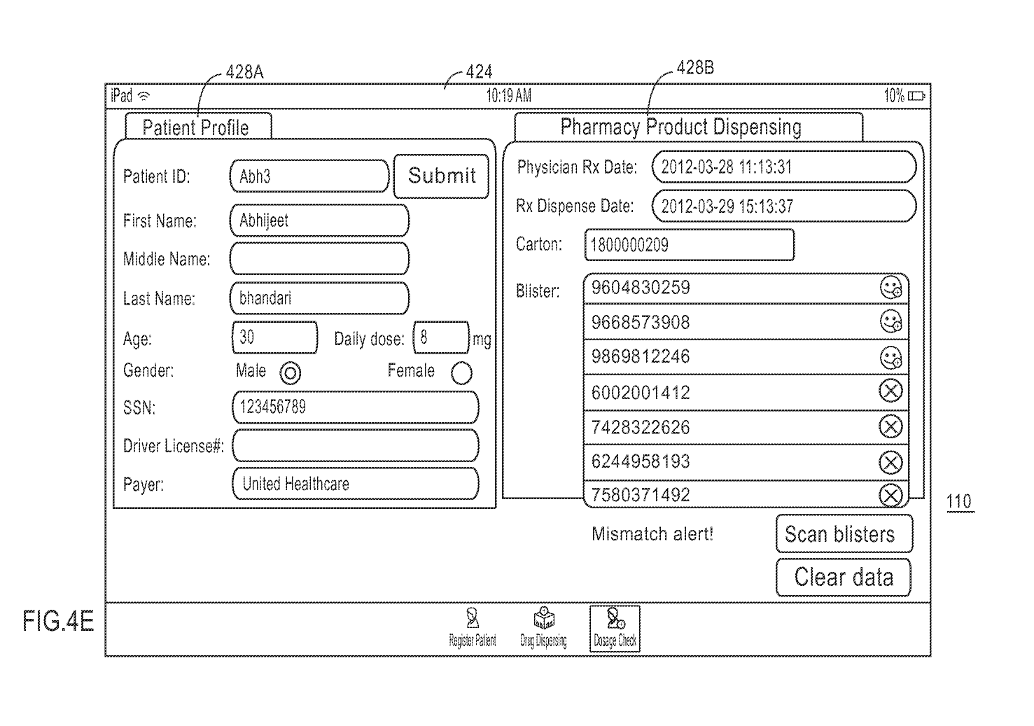

Referring again to FIG. 1, in some embodiments, the monitor interface 110 provides a patient registration interface for receiving the patient information. In this manner, a prescribing physician can register the patient at the time of prescribing the controlled drug. FIG. 4A illustrates an exemplary patient registration interface 414 having fields for a user such as a pharmacist to specify a patient's first name, middle name, last name, and a patient identifier. The physician can then click the “Submit” button to transmit the information to the compliance monitor 140 for patient registration, as described later.

In some embodiments, the monitor interface 110 provides a drug dispensing interface, usable by a dispensing pharmacy for example, for receiving the prescription data, and for receiving either a specification of an already registered patient or the patient information. In other words, a previously registered patient will not have to register again, while a new patient can be registered at the pharmacy itself. The specification of the patient can be any aspect of the patient information, such as a patient identifier. In some embodiments, the prescription data received by the drug dispensing interface includes a box code and/or one or more dosage codes associated with the dispensed drug, as discussed earlier.

FIG. 4B illustrates an exemplary drug dispensing interface 418 having fields for a user such as a pharmacist and/or any drug dispensing entity to dispense the controlled drug to a patient per a prescription. A patient profile section 420A of the drug dispensing interface 418 provides fields that permit the pharmacist to specify an existing patient by providing a patient ID and clicking ‘Submit’, which populates the remaining fields of the patient profile section 420A if the patient ID exists. The pharmacist can also add and save patient information for already registered patients, such as age, gender, SSN, the daily dose the patient is prescribed to take, driver license number, and an insurance provider and/or payer. A dispensing section 420B of the drug dispensing interface 418 permits the pharmacist to provide the date of the prescription, and also provides a ‘Carton’ field where a pharmacist can enter a box code of a dispensed prescription, or click a ‘Scan’ button to scan the box code into the ‘Carton’ field. The pharmacist can then click a ‘Get Contents’ button to retrieve the dosage codes associated with the box code from a serialization database. The ‘Blister’ field is then populated with the retrieved dosage codes. The pharmacist can click the ‘Dispense’ button to associate the patient profile from the patient profile section 420A with the prescription information in the dispensing section 120B.

In some embodiments, the monitor interface 110 provides a dosage check interface for communicating an indication of compliance and/or drug diversion to a user. An exemplary dosage check interface 424 is illustrated in FIG. 4C, and includes a patient profile section 428A similar to the patient profile section 420A. The dosage check interface 424 also includes a dosage check section 428B that can receive a specification of a box code in a ‘Carton’ section and dosage codes in a ‘Blister’ section. The ‘Blister’ section is populated when a user such as a law enforcement official scans individual pill packets using the ‘Scan blisters’ button.

In some embodiments, the dosage checker interface is operable to receive a patient specification and scanned dosage codes associated with a controlled drug, and is operable to communicate, in any suitable manner, an indication of whether the patient is in possession of the controlled drug. In some embodiments, communication by the dosage checker interface includes providing one or more of a visual indicator, an audible indicator, an indicator of whether a scanned dosage code corresponds to the received patient, and/or the like. In some embodiments, the dosage checker interface is operable to communicate an indication of whether the patient is compliant with a dosing schedule, the communication including providing one or more of a visual indicator, a text indicator, an audible indicator, and/or the like.

FIG. 4D illustrates an exemplary screenshot of the dosage checker interface of FIG. 4C where each scanned dosage code listed in the ‘Blisters’ field of the dosage check section 428B has an icon indicating a match with the patient specified in the patient profile section 428A. FIG. 4E illustrates an exemplary screenshot of the dosage checker interface of FIG. 4C where some scanned dosage codes listed in the ‘Blisters’ field of the dosage check section 428B have icons indicating a match with the patient specified in the patient profile section 428A. A text indicator stating ‘mismatch alert!’ is also provided in the dosage check section 428B.

In some embodiments, the dosage checker interface receives (via an input device of the monitor interface 110 as described earlier) scanned codes associated with a controlled drug, and is operable to communicate prescription data and/or patient information associated with the scanned codes. In some embodiments, the scanned codes are associated with the prescription data of a single patient, and the communicated prescription data and/or patient information corresponds to the single patient. In some embodiments, the scanned codes are associated with multiple prescription data, and the communicated prescription data reflects the multiple prescription data in any suitable manner. Any number of prescriptions, each referring to a particular drug, can be accommodated by this system. For example, the multiple prescription data may be presented as a selectable list of multiple prescription numbers, where a user can view detailed prescription data for a single identifier by clicking on it and/or otherwise selecting it. In some embodiments, the scanned codes are associated with multiple patients, and the communicated prescription data reflects the multiple patients in any suitable manner, such as a selectable list of multiple patient identifiers, for example.

Referring again to FIG. 1, the compliance monitor 140 is configurable to receive the patient information and/or the prescription data from the monitor interface 110, and to determine whether the patient is compliant with the prescription data. In some embodiments, the compliance monitor is configurable to receive one or more dosage codes that are associated with a dispensed prescription, and to determine whether the dispensed prescription was diverted.

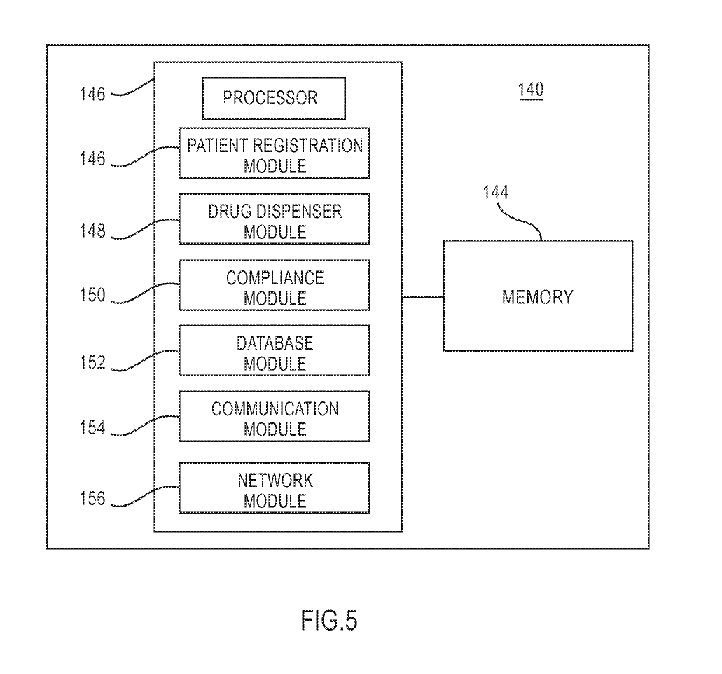

FIG. 5 illustrates various components of the compliance monitor 140 according to some embodiments. The compliance monitor 140 includes at least a processor 142 and a memory 144. The processor 140 can include a patient registration module 146, a drug dispenser module 148, a compliance module 150, a database module 152, each explained in more detail below. The processor 140 can also include a communication module 154 for enabling seamless input/output data flow between the compliance monitor 140 and the monitor interface 110, as well as between the compliance monitor and the database 180. The processor 140 can also include a network module 156 for establishing and managing network connectivity of the compliance monitor 140 within the system 100.

It is to be understood that the functionality of the various modules of the compliance monitor 140 can overlap, and that two or more modules can be combined. For example, the patient registration module 146 and the drug dispenser module 148 may be partly or wholly combined in some embodiments, since both provide for patient registration (described later). It is also to be to understood that the each of the modules may be in seamless communication with each other module.

In some embodiments, the patient registration module 146 can be configured to receive an identification of a patient from the monitor interface 110 (e.g. from the patient registration interface) via the communication module 154 for purposes of registering the patient. In some embodiments, the patient registration module 146 is further configurable to store the patient identification in the database 180, via the database module 152 for example. In some embodiments, the patient registration module 146 is configurable to check if the patient identification already exists in the database 180, and to communicate the error to the monitor interface 110 via the communication module 154. For example, the patient registration module 146 can indicate that the patient identifier already exists in the database 180. In some embodiments, the patient registration module 146 is configurable to generate a patient identifier to include in the received patient identification when, for example, the received patient identification does not include a patient identifier, when the received patient identifier already exists in the system, when the received patient identifier does not meet certain requirements such as a minimum string length, and/or the like. In some embodiments, the patient registration module 146 communicates the generated patient identifier to the user via the monitor interface 110.

Still referring to FIG. 5, the drug dispenser module 148 can be configured to receive prescription information from the monitor interface 110 via the communication module 154 for purposes of dispensing the controlled drug to a registered or new patient. In some embodiments, the drug dispenser module 148 receives a specification of a previously registered patient, and is configurable to retrieve the patient information from the database 180. In some embodiments, the drug dispenser module 148 receives an updated specification of a previously registered patient (e.g. as determined by the patient identifier), and is configurable to update the database entry for the previously registered patient with the updated specification. In some embodiments, the drug dispenser module 148 receives an identification of a new patient, and is configurable to register the new patient, either directly and/or via the patient registration module 146 as described above.

In some embodiments, the drug dispenser module 148 receives prescription information from the monitor interface 110 that includes a box code associated with a box of the controlled drug being dispensed, and is configurable to retrieve one or more dosage codes associated with the received box code in any suitable manner. In some embodiments, the drug dispenser module 148 retrieves the one or more dosage codes from a serialization database. In some embodiments, the database 180 includes the serialization database. The drug dispenser module 148 is further configurable to communicate the retrieved one or more box codes to the monitor interface 110, and to include the retrieved one or more box codes in the prescription information.

The drug dispenser module 148 is further configurable for linking, interlinking, combining, merging, and/or otherwise associating the received prescription information and the specification of registered patient, and for communicating an indication that the association was successful to the monitor interface 110. In some embodiments, the drug dispenser module 148 can be configured to store the associated prescription information and patient specification in the database 180 via database module 152.

Still referring to FIG. 5, the compliance module 150 can be configured to receive one or more dosage codes from the monitor interface 110 via communication module 154, such as those associated with a previously dispensed prescription. In some embodiments, the compliance module 150 also receives a specification of a registered patient, and can be configured to retrieve from database 180 the prescription information associated with the registered patient. The compliance module 150 can then determine whether the patient is compliant with the prescription in any suitable manner.

In some embodiments, the compliance module 150 compares the received dosage codes with the dosage codes of the retrieved prescription information, and determines that the patient is in improper possession of controlled drugs and/or otherwise noncompliant with the prescription if at least one dosage code associated with the dispensed prescription does not match at least one of the dosage codes of the prescription data. In some embodiments, the compliance module 150 reads and/or gleans a dosing schedule from the prescription information and/or the patient information. For example, the compliance module 150 might deem, by default, that a patient is supposed to take one unit dosage (associated with a single dosage code) of the dispensed prescription per day. In some embodiments, the prescription information might specify a dosing schedule for the dispensed prescription (e.g. twice a day), and the compliance module 150 is configurable to read this information. In some embodiments, the compliance module 150 is configurable to access a third-party database and/or system (not shown) to determine a known dosing schedule associated with the dispensed prescription. In some embodiments, the dosing schedule can be gleaned from the patient information. For example, the exemplary embodiments of FIGS. 4C-4E illustrate a ‘Daily dose’ field as part of the patient profile section 428A, and the compliance module 150 can use this information to determine if the patient has used the correct number of pill packets.

In some embodiments, the number of received, valid unit dosage codes corresponds to those dosages that have not been consumed (e.g. when the dosage codes include first and second indicators, as described earlier), and the compliance module 150 determines that the patient is compliant when the number of received dosage codes corresponds to a remainder dosing schedule and/or remainder duration of the dosing schedule. In some embodiments, the number of received, valid unit dosage codes corresponds to those dosages that have been consumed, and the compliance module 150 determines that the patient is compliant when the number of received dosage codes corresponds to a past dosing schedule and/or past duration of the dosing schedule. In some embodiments, the compliance module 150 determines that the patient is compliant with the dosing schedule and/or in proper possession of the dispensed prescription when some of the received dosage codes correlate with the remainder duration of the dosing schedule, and the rest of the received dosage codes correlate with a past duration of the dosing schedule. The compliance module is further configurable for communicating an indication of whether the patient is compliant and/or in proper possession to the monitor interface 110.

In some embodiments, the compliance module 150 receives one or more dosage codes from the monitor interface 110 via communication module 154 and associated with a dispensed prescription. The compliance module 150 can then determine the prescription information and/or patient information associated the received dosage codes. In some embodiments, the compliance module 150 queries the database 180 via the database module 152 for retrieving prescription information containing the received dosage codes. The compliance module 152 is further configurable for communicating an indication of the retrieved prescription information to the monitor interface 110 via the communication module 154. In some embodiments, the received dosage codes correspond to prescription information for multiple dispensed prescriptions, and the compliance module is configurable for communicating an indication of the multiple dispensed prescriptions to the monitor interface 110.

In some embodiments, the compliance module 150 can further query the database 180 via the database module 152 for retrieving patient information associated with the retrieved prescription information. In some embodiments, the prescription information correlates with multiple dispensed prescriptions, and the compliance module 150 is configurable to retrieve patient information for all patients associated with the multiple dispensed prescriptions. In some embodiments, the prescription information corresponds to multiple dispensed prescriptions, and the compliance module 150 is configurable to retrieve patient information for a selected subset (e.g. as can be provided by a user of the monitor interface 110) of the multiple dispensed prescriptions.

Still referring to FIG. 5, the database module 152 is configurable for accessing and manipulating the database 180, and/or other databases (not shown). In some embodiments, the database module 152 can control access to database 180 based on user credentials of a user of the system 100, as is known in the art. For example, in some embodiments a user logged in as a pharmacist can be permitted to view patient and prescription information, while a user logged in as a law enforcement official can be limited to viewing prescription information only. In this manner, the database module 152 can be configurable and/or otherwise programmable to comply with prevailing regulatory guidelines for protecting electronic personal health information, such as, but not limited to, the Security Rule of the HIPAA Administrative Simplification provisions.

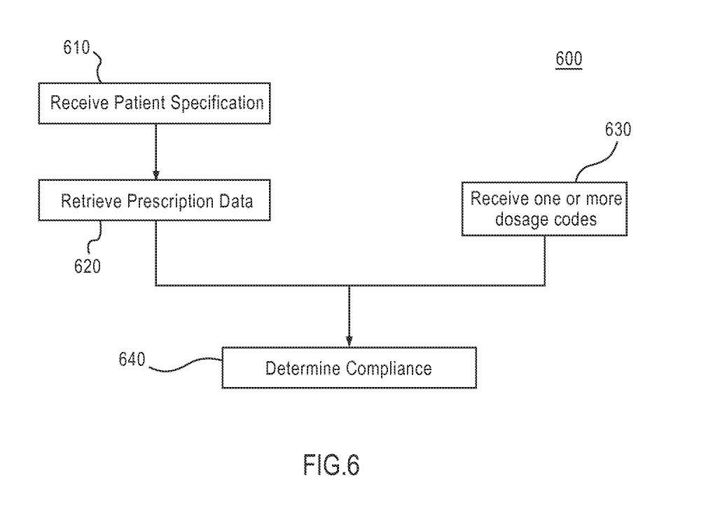

Aspects of the invention are also directed to a method 600 of patient compliance monitoring, as generally illustrated in FIG. 6, and described herein with respect to the illustrations and associated descriptions of FIGS. 1 and 4. In some embodiments, the method 600 is executed by the compliance module 150 of the compliance monitor 140. The method 600 includes, at 610, receiving a specification of a registered patient from the dosage check interface of the monitor interface 110 at the compliance monitor 150. The specification includes at least one of a patient identifier of the patient, a name of the patient, an age of the patient, a gender of the patient, a daily dosage for the patient, a social security number of the patient, a driver license number of the patient, or a prescription drug coverage provider of the patient.

At 620, prescription data and/or information is retrieved from the database 180 via the database module 152 that is associated with the received patient specification. The prescription data includes at least one of a prescription number, a prescription date, an identifier of a prescription drug of the dispensed prescription, a dispense date, a box code associated with the dispensed prescription, or one or more dosage codes associated with the box code. In some embodiments, the prescription data is retrieved based on a regulatory standard such as HIPAA.

At 630, one or more scanned dosage codes are received from the monitor interface 110 that can be associated with a dispensed prescription. Each dosage code can be associated with a unit dosage of a prescription drug of the dispensed prescription. In some embodiments, each dosage code includes a serialization code. In some embodiments, the serialization code includes at least one of an alphanumeric string or a barcode. In some embodiments, the barcode is at least one of a quick response (QR) barcode, a universal product code (UPC), or a unique three dimensional structure.

As illustrated in FIG. 6, step 630 can occur independent of steps 610 and 620. Said another way, step 630 can occur simultaneously, prior to, or after either of the steps 610 and 620. At 640, compliance of the registered patient with the prescription information and/or whether the registered patient is in legal possession of the dispensed prescription based on the prescription information and the scanned dosage codes is determined. In some embodiments, compliance is determined by comparing the dosage codes of the prescription data to the scanned dosage codes of the dispensed prescription, and the patient is determined to be noncompliant when at least one of the scanned dosage codes associated with the dispensed prescription does not match at least one of the dosage codes of the prescription data.

In some embodiments, compliance is determined by retrieving a dosing schedule associated with the prescription data, and comparing the dosing schedule with the scanned dosage codes of the dispensed prescription. In some embodiments, the scanned dosage codes are associated with a number of unit dosages of a prescription drug of the dispensed prescription indicated as not being consumed by the patient, and determining whether the patient is compliant includes determining that the patient is compliant when the number of unit dosages indicated as not being consumed by the patient correlates with a remainder duration of the dosing schedule. In some embodiments, the scanned dosage codes are associated with a number of unit dosages of a prescription drug of the dispensed prescription indicated as being consumed by the patient, and determining whether the patient is compliant includes determining that the patient is compliant when the number of unit dosages indicated as being consumed by the patient correlates with a past duration of the dosing schedule. In some embodiments, each dosage code includes a first indicator and a second indicator, and at least one of the first and second indicators is associated with a number of unit dosages of the dispensed prescription not consumed by the patient. The patient is determined to be compliant when the number of unit dosages not consumed by the patient correlates with a remainder duration of the dosing schedule.

In some embodiments, the method 600 can also include, prior to steps 610, 620 and 630, receiving an identification of the patient and storing the identification of the patient to define the specification of the patient, at the patient registration module 146 for example. The method can also include receiving the prescription data and associating the prescription data with the specification of the patient to define associated prescription data, at the drug dispenser module 148, for example. The associated prescription data is then stored in the database 180 to define the prescription data associated with the specification.

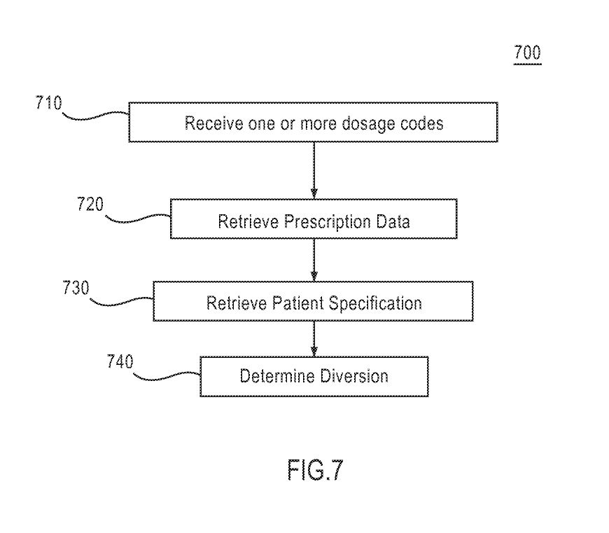

Aspects of the invention are also directed to a method 700 of prescription drug tracking, as generally illustrated in FIG. 7, and described herein with respect to the illustrations and associated descriptions of FIGS. 1 and 5. In some embodiments, the method 700 is executed by the compliance module 150 of the compliance monitor 140. The method 700 includes, at 710, receiving one or more scanned dosage codes at the compliance monitor 140 from the monitor interface 110. The dosage code(s) can be any unique identifier associated with the single dose. In some embodiments, the dosage code(s) is located on the pill packet and can be one or more of quick response (QR) bar codes, universal product codes (UPC), three dimensional (3D) structures, an alphanumeric string such as a serialization number, radio-frequency identification (RFID) codes, and/or the like.

In some embodiments, the dosage code includes at least one unique characteristic or metric of the pill itself as described in the '320 application incorporated by reference above. For example, every manufactured good such as a drug capsule, tablet, pill, etc. has an inherent, unique feature viewable on at least some level of magnification, and can be one or more of a unique pattern, thickness, topography, unique features intentionally formed on the pill, unique features embedded in and/or on the pill such as small flecks, unique features printed on the pill, and/or the like. In this manner, even a pill that is found without a pill packet, or in partially damaged condition, can still potentially be tracked back to its associated patient, dispensing pharmacy, and its particular supply chain. There is hence a significant deterrence for patients to not only sell or transfer their prescribed controlled drugs, but to improperly buy or receive controlled drugs from others.

At 720, prescription data is retrieved from the database 180 via the database module 152 that includes at least one dosage code from the scanned dosage codes. In some embodiments, the dosage code for each pill packet includes at least one unique metric of the pill (e.g. a field image of randomly distributed reflective flecks printed on the pill surface), and further includes at least one unique identifier of the pill packet (e.g. a unique serialization code). The database 180 then stores, as the dosage code, the unique metric as linked to the unique identifier, and the database module 152 is operable to retrieve one based on the other due to said linking. At 730, patient specification is retrieved from the database 180 that is associated with the prescription data.

At 740, it is determined, based on the patient specification, whether the dispensed prescription was dispensed to the patient. By scanning the unit of sale, or more likely the unit of use codes, it can be determined if the patient is the authorized recipient. If he is not, the system can track back through unit of use-unit of sale-pharmacy, Rx # to the diverting party and his prescriber.

Some embodiments described herein relate to a computer storage product with a non-transitory computer-readable medium (also referred to as a non-transitory processor-readable medium) having instructions or computer code thereon for performing various computer-implemented operations. The computer-readable medium (or processor-readable medium) is non-transitory in the sense that it does not include transitory propagating signals (e.g., a propagating electromagnetic wave carrying information on a transmission medium such as space or a cable). The media and computer code (also referred to herein as code) may be those designed and constructed for the specific purpose or purposes. Examples of non-transitory computer-readable media include, but are not limited to: magnetic storage media such as hard disks, optical storage media such as Compact Disc/Digital Video Discs (CD/DVDs), Compact Disc-Read Only Memories (CD-ROMs), magneto-optical storage media such as optical disks, carrier wave signal processing modules, and hardware devices that are specially configured to store and execute program code, such as Application-Specific Integrated Circuits (ASICs), Programmable Logic Devices (PLDs), Read-Only Memory (ROM) and Random-Access Memory (RAM) devices.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using Java, C++, or other programming languages and/or other development tools.

The various embodiments described herein should not to be construed as limiting this disclosure in scope or spirit. It is to be understood that no limitation to the scope of the disclosure is intended thereby. It is to be further understood that resort may be had to various other embodiments, modifications, and equivalents thereof which may suggest themselves to those skilled in the art without departing from the spirit of the present disclosure and/or scope of the appended claims.

Those skilled in the art will recognize, or be able to ascertain, using no more than routine experimentation, numerous equivalents to the specific embodiments described specifically herein. Such equivalents are intended to be encompassed in the scope of the following claims.

1. A method of patient compliance monitoring, comprising:
receiving, from a user, a specification of a patient;
retrieving prescription data associated with the specification;
receiving one or more serial numbers uniquely identifying the unit of sale associated with a dispensed prescription;
determining whether the patient is compliant with the prescription data as a function of the prescription data and the one or more codes; and
communicating an indication of whether the patient is compliant to the user.

2. The method of claim 1, further comprising:
Recording a locator code associated with a dispensing pharmacy.

2. The method of claim 1, wherein the specification includes at least one of a patient identifier of the patient, a name of the patient, an age of the patient, a gender of the patient, a daily dosage for the patient, a social security number of the patient, a driver license number of the patient, or a provider number.

3. The method of claim 1, wherein the prescription data includes at least one of a prescription number, a prescription date, a locator number of the dispensing pharmacy, an identifier of a prescription drug of the dispensed prescription, a dispense date, a unique box code associated with the dispensed medication (unit of sale), or one or more dosage codes associated with the unique box code.

4. The method of claim 1, wherein the prescription data includes one or more codes, the determining whether the patient is compliant includes:
comparing the one or more codes of the prescription data to the one or more unique serial numbers associated with the dispensed prescription; and
determining that the patient is noncompliant when at least one of the one or more codes associated with the dispensed prescription does not match at least one of the one or more codes of the prescription data.

5. The method of claim 1, wherein the determining whether the patient is compliant includes:
retrieving a dosing schedule associated with the prescription; and
comparing the actual units of use, uniquely numbered, with the elapsed time since dispensing of the prescription

6. The method of claim 5, wherein the one or more codes are associated with a number of unit dosages of a prescription drug of the dispensed prescription indicated as not being consumed by the patient, the determining whether the patient is compliant includes determining that the patient is compliant when the number of unit dosages indicated as not being consumed by the patient correlates with a remainder duration of the dosing schedule.

7. The method of claim 5, wherein the one or more codes are associated with a number of unit dosages of a prescription drug of the dispensed prescription indicated as being consumed by the patient, the determining whether the patient is compliant includes determining that the patient is compliant when the number of unit dosages indicated as being consumed by the patient correlates with a past duration of the dosing schedule.

8. The method of claim 1, wherein the retrieving prescription data includes accessing a database that associates the patient identity with the prescription data.

9. The method of claim 1, wherein each code from the one or more codes is associated with a unit dosage of a prescription drug of the dispensed prescription.

10. The method of claim 1, wherein each code from the one or more codes includes a serialization code.

11. The method of claim 10, wherein the serialization code of each code from the one or more codes includes at least one of an alphanumeric string or a barcode.

12. The method of claim 11, wherein the barcode is at least one of a quick response (QR) barcode, a universal product code (UPC), or a unique three dimensional structure.

13. The method of claim 1, further comprising, prior to the receiving the specification and prior to the retrieving the prescription data:
receiving an identification of the patient;
storing the identification of the patient to define the specification of the patient;
receiving the prescription data;
associating the prescription data with the specification of the patient to define associated prescription data; and
storing the associated prescription data to define the prescription data associated with the specification.

14. The method of claim 13, receiving the prescription data includes:
receiving a box code uniquely associated with the dispensed prescription, the one or more codes associated with the box code.

15. The method of claim 1, wherein each code from the one or more codes includes a first indicator and a second indicator, at least one of the first indicator and the second indicator is associated with a number of unit dosages of a prescription drug of the dispensed prescription not consumed by the patient, the determining whether the patient is compliant includes determining that the patient is compliant when the number of unit dosages not consumed by the patient correlates with a remainder duration of the dosing schedule.

16. The method of claim 1, wherein the retrieving the prescription data is based on a regulatory standard.

17. A method of prescription drug tracking, comprising:
receiving one or more codes associated with a dispensed prescription;
retrieving prescription data associated with at least one code from the one or more codes;
retrieving a specification of a patient associated with the prescription data;
determining whether the dispensed prescription was diverted as a function of the specification of the patient; and
communicating an indication of whether the dispensed prescription was diverted to a user.

18. The method of claim 17, wherein the retrieving the patient specification is based on a regulatory standard.

19. The method of claim 17, wherein the patient specification includes at least one of a patient identifier, a name of the patient, an age of the patient, a gender of the patient, a daily dosage for the patient, a social security number of the patient, a driver license number of the patient, or an insurance unit number of the patient.

20. The method of claim 17, wherein the prescription data includes at least one of a prescription number, a prescription date, an identifier of a prescription drug of the dispensed prescription, a dispense date, a box code uniquely associated with the dispensed prescription, or one or more codes associated uniquely with the box code.

21. The method of claim 17, wherein said determining whether the dispensed prescription was diverted includes_.

22. The method of claim 17, wherein said retrieving the specification of the patient includes accessing a database that associates the specification with the prescription data.

23. The method of claim 17, wherein each code from the one or more codes is associated with unit doses of a prescription drug of the dispensed prescription.

24. A compliance monitoring apparatus, comprising:
a patient registration module implemented in at least one of a memory or a processing device, the patient registration module configured to receive an identification of a patient;
a drug dispenser module configured to:
receive prescription data; and
link the prescription data with the identification of the patient;
a compliance module configured to:
receive a specification of the patient;
retrieve the prescription data associated with the patient;
receive one or more unique codes associated with a dispensed prescription; and
determine whether the patient is compliant as a function of the prescription data and the one or more codes; and
a communication module configured to communicate an indication of whether the patient is compliant.

25. A diversion tracking apparatus, comprising:
a patient registration module implemented in at least one of a memory or a processing device, the patient registration module configured to receive an identification of a patient;
a drug dispenser module configured to:
receive prescription data; and
link the prescription data with the patient;
a compliance module configured to:
receive one or more codes associated with a dispensed prescription;
retrieve prescription data associated with at least one code from the one or more codes;
retrieve a specification of a patient associated with the prescription data;
and
determine whether the dispensed prescription was diverted as a function of the specification of the patient; and
a communication module configured to communicate whether the prescription was diverted.
